(19) United States
(12) Patent Application Publication
(10) Pub. No.: US 2006/0193207 A1
(43) Pub. Date: Aug. 31, 2006

(54) Large area tightly coupled attitude, position, velocity, and acceleration mapping system

(75) Inventor: Zygmunt Zubkow, Palm Harbor, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/058,765

(22) Filed: Feb. 16, 2005

(51) Int. Cl. G01V 1/18

(52) U.S. Cl. 367/178

(57) ABSTRACT

Systems and methods for monitoring and tracking transients caused by geological events are provided. The system comprises a sensor array and a central monitoring system. The central monitoring system is adapted to communicate with the sensor array. The sensor array measures motion at a plurality of locations and transmits time stamped data characterizing the geologic activity at the plurality of locations to the central monitoring system. The central monitoring system is further adapted to correlate the time stamped data and map geological disturbances in real time.

### TECHNICAL FIELD

The present invention generally relates to detection of geological events and more specifically to a large area tightly coupled attitude, position, velocity, and acceleration mapping system.

### BACKGROUND

Tsunami disasters have emphasized the need for accurate systems for quickly identifying and tracking transients cause by significant geologic disturbances. Current systems in the art today consist mostly of seismographs, and other similar devices, which are single point data sources that measure accelerations from forces experienced at a single location. Such single point devices are not well suited for tracking and mapping three dimensional transients propagating through the Earth in real time (i.e. as the transients are occurring). Three dimensional real time tracking of geological transients can provide scientists and civil authorities with superior data for the purpose of issuing earthquake and tsunami warnings.

For the reasons stated above and for other reasons stated below which will become apparent to those skilled in the art upon reading and understanding the specification, there is a need in the art for systems and methods for tracking and mapping transient conditions caused by geologic events, such as geologic disturbances, in three dimensions and in real time.

### SUMMARY

The Embodiments of the present invention provide systems and methods for tracking and mapping transient conditions caused by geologic disturbances, in three dimensions and in real time, and will be understood by reading and studying the following specification.

In one embodiment, a geological event monitoring system is provided. The system comprises a sensor array and a central monitoring system. The central monitoring system is adapted to communicate with the sensor array. The sensor array measures activity at a plurality of locations and transmits time stamped data characterizing the activity at the plurality of locations to the central monitoring system. The central monitoring system is further adapted to correlate the time stamped data and map geological events in real time.

In another embodiment, another geological disturbance monitoring system is provided. The system comprises a plurality of means for geologic activity sensing, wherein each means for geologic activity sensing is adapted to monitor and capture motion data including at least one of the means for geologic activity sensing's attitude, position, acceleration, and velocity. The system further comprises means for capturing motion data sensed by the plurality of means for motion sensing, means for time stamping the motion data captured, means for correlating the time stamped motion data, and means for mapping one or more geological disturbances in real time, based on correlated time stamped motion data.

In yet another embodiment, a method for locating underground oil and mineral deposits is provided. The method comprises producing one or more traveling shock waves through a geographic area; sensing shock wave motions at a plurality of locations within the geographic area; capturing shock wave motion data based on the sensed shock wave motion at the plurality of locations within the geographic area; time stamping the shock wave motion data with a time indicating when the shock wave motion data was captured; calculating one or more of frequency, amplitude, speed and direction of the one or more traveling shock waves, and generating a map of deposits located within the geographic area by evaluating the time stamped motion data.

In yet another embodiment, a method for monitoring geological events is provided. The method comprises capturing motion data at a plurality of locations within a geographic area, time stamping the motion data captured at a plurality of locations within a geographic area, correlating the time stamped motion data, and tracking the location and intensity of one or more waves generated by one or more geological events.

In yet another embodiment, a computer-readable medium having computer-executable program instructions for a method for monitoring geological events is provided. The method comprises capturing motion data at a plurality of locations within a geographic area; time stamping the motion data captured at a plurality of locations within a geographic area; correlating the time stamped motion data; and tracking the location and intensity of one or more waves generated by one or more geological events.

In still another embodiment, a computer-readable medium having computer-executable program instructions for a method for locating underground oil and mineral deposits is provided. The method comprises producing one or more traveling shock waves through a geographic area; sensing shock wave motions at a plurality of locations within the geographic area; capturing shock wave motion data based on the sensed shock wave motion at the plurality of locations within the geographic area; time stamping the shock wave motion data with a time indicating when the shock wave motion data was captured; calculating one or more of frequency, amplitude, speed and direction of the one or more traveling shock waves; and generating a map of deposits located within the geographic area by evaluating the time stamped motion data.

### DRAWINGS

The present invention can be more easily understood and further advantages and uses thereof more readily apparent, when considered in view of the description of the preferred embodiments and the following figures in which:

FIG. 1a is a diagram illustrating a sensor array and central monitoring system of one embodiment of the present invention;

FIG. 1b is a block diagram illustrating a geologic activity sensor and a central monitoring system of one embodiment of the present invention;

FIGS. 2a and 2b are illustrations of a sensor array and central monitoring system capturing wave motion of one embodiment of the present invention;

FIGS. 3a and 3b are illustrations of a sensor array measuring tectonic plate shifts of one embodiment of the present invention;

FIG. 4 is a flow diagram illustrating a method for detecting movements cause by geological disturbances of one embodiment of the present invention;

FIG. 5 is a block diagram illustrating a system for detecting the location of underground oil and mineral deposits of one embodiment of the present invention; and

FIG. 6 is a flow diagram illustrating a method for detecting underground oil and mineral deposits of one embodiment of the present invention.

In accordance with common practice, the various described features are not drawn to scale but are drawn to emphasize features relevant to the present invention. Reference characters denote like elements throughout Figures and text.

### DETAILED DESCRIPTION

Fast and accurate mapping of low frequency traveling waves and movements of tectonic plates caused by geological disturbances provides information to scientists and local authorities which enables them to predict and pinpoint the locations of earthquakes and tsunamis. With these predictions, authorities are able to issue appropriate evacuation warnings to people in harms way. Embodiments of the present invention provide highly accurate measurements of geologic accelerations and velocities over large geographic areas, coordinated in time to produce real time three dimensional maps of geological disturbances and their affects on geological structures.

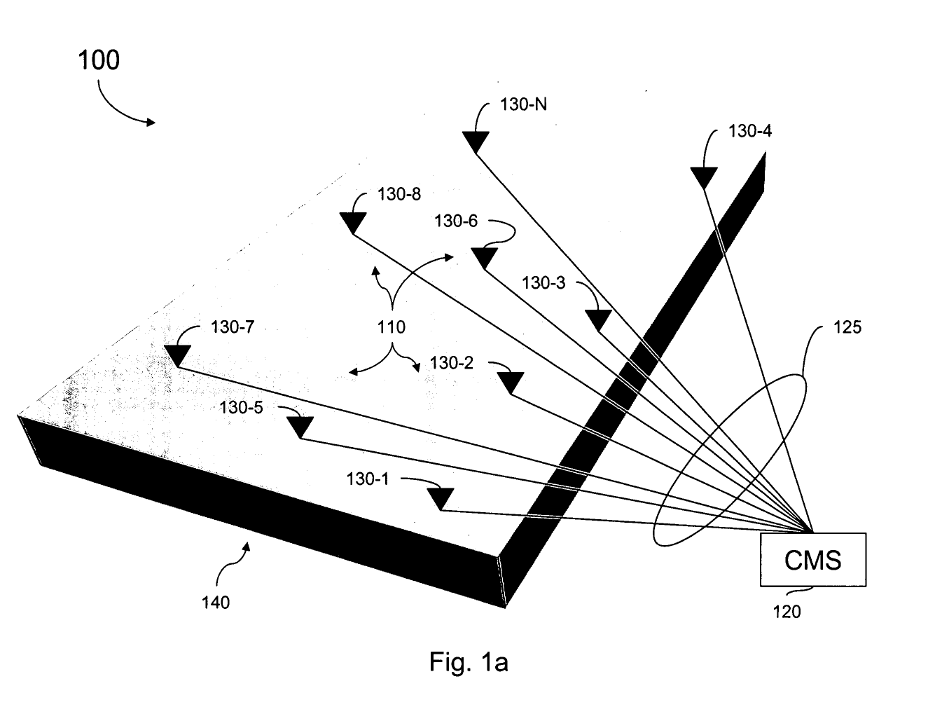

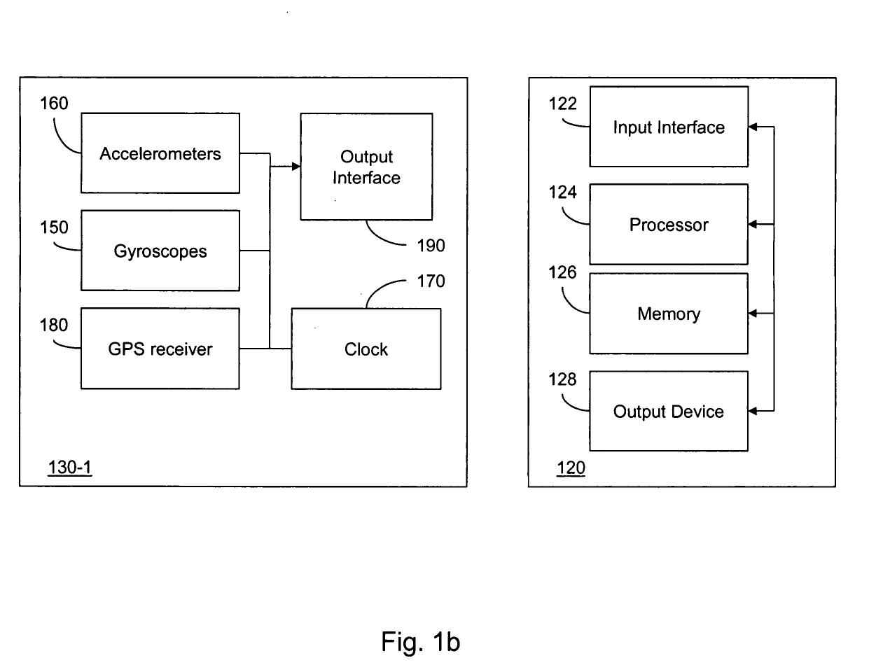

As illustrated in FIG. 1a, embodiments of the present invention comprise a sensor array 110 and a central monitoring system (CMS) 120, both adapted to communicate with each other via one or more communication links 125. Sensor array 110 includes a plurality of geologic activity sensors 130-1 to 130-N dispersed across a geographical region 140. In one embodiment, geographical region 140 is a tectonic plate. There is no upper limit to the size of the geographical region 140 monitored by sensor array 110. In one embodiment, geographical region 140 may include two or more tectonic plates. One embodiment of the present invention may include a sensor array 110 of geologic activity sensors 130-1 to 130-N distributed throughout the entire surface of the earth and below the surface of the earth.

FIG. 1b, illustrates one embodiment of a first geologic activity sensor 130-1 of the plurality of geologic activity sensors 130-1 to 130-N of the present invention. Geologic activity sensor 130-1 comprises one or more of gyroscopes 150, accelerometers 160, a clock 170, and a global positioning system receiver 180 which allow each sensor to monitor and capture the sensor's attitude (e.g. the sensor's roll, pitch, and yaw), position (e.g. longitude, latitude and altitude), acceleration (e.g. linear and rotational direction and magnitude) and velocity (e.g. linear and rotational direction and magnitude). In one embodiment, geologic activity sensors 130-1 to 130-N are adapted to capture geologic activity data including one or more of attitude, position, acceleration and velocity data each at a rate of 256 data samples per second. In one embodiment, sensor array 110 can measure accelerations down into the micro-g. As data is captured, clock 170 time stamps each data sample with the precise time the data sample was captured. In one embodiment, clock 170 is adapted to receive a precision time signal from global positioning system (GPS) receiver 180. In one embodiment, clock 170 is integrated into GPS receiver 180. In one embodiment, one or more clocks 170 for the plurality of geologic activity sensors 130-1 to 130-N are synchronized together using GPS satellite clock signals. In one embodiment, geologic activity sensor 110 is adapted to communicate time stamped attitude, position, acceleration and velocity data to central monitoring system 120 through output interface 190. In one embodiment, output interface 190 includes one or more of, but not limited to, a 1553B standard bus interface, an RS-422 data bus, an Ethernet interface, an optical fiber interface and a wireless RF interface. In one embodiment geologic activity sensor 110 is a commercially available inertial navigation unit adapted with a GPS receiver. In one embodiment, geologic activity sensor 110 is an Embedded GPS/INS (EGI) system such as the Honeywell EGI. In one embodiment, central monitoring system 120 comprises an input interface 122 adapted to communicate with the plurality of geologic activity sensors 130-1 to 130-N, a processor 124, a memory 126, and an output device 128. In one embodiment, output device 128 includes one or more of a video display terminal and a printer.

In one embodiment geologic activity data from sensor array 110 is collected to central monitoring system 120 via communications link 125. In one embodiment, communications link 125 is a MIL-STD-1553 interface bus wherein each geologic activity sensor 130-1 to 130-N is assigned a different address. Communications link 125 can stream data from geologic activity sensors 130-1 to 130-N via other communications media including, but not limited to fiber-optics, Ethernet, co-axial cable, wireless transmission, and the like.

In one embodiment, central monitoring system 120 receives the time-stamped activity data from geologic activity sensors 130-1 to 130-N, and creates a multi-dimensional map from the activity data. There are several means available to those skilled in the art to create a multi-dimensional map from data simultaneously collected from a multitude of sampling points, such as the above described geologic activity data. As one example, in one embodiment of the present invention, central monitoring system 120 creates an activity vector comprising two or more activity data samples acquired from a first geologic activity sensor 130-1 of geologic activity sensors 130-1 to 130-N. Activity data samples comprising the geologic activity sensor's roll, pitch, and yaw, longitude, latitude, altitude and linear acceleration magnitude, all captured at a single point in time, form an eight-dimensional activity vector, which can be expressed as:
Activity_1(roll, pitch, yaw, longitude, latitude, altitude, linear acceleration magnitude, time_n)
   Activity_1 is essentially a snapshot of activity data samples captured by the geologic activity sensor 130-1 at time_n.

In one embodiment, central monitoring system 120 is adapted to generate a multi-dimensional graphical representation of vector Activity_1. In one embodiment, central monitoring system 120 is adapted to receive a string of m vectors, such as Activity_1, comprising activity data samples acquired from first geologic activity sensor 130-1 at times time_n to time_n+m. With this string of vectors, central monitoring system 120 is enabled to plot one or more dimensions of the string of vectors over the time interval from time_n to time_n+m. For instance, in one embodiment, central monitoring system 120 plots the linear acceleration magnitude, experienced by geological activity sensor 130-1 from time_n to time_n+m. In another embodiment, central monitoring system 120 generates a graphical representation of the roll, pitch and yaw of geological activity sensor 130-1 from time_n to time_n+m.

In embodiments of the present invention, geologic activity data captured from each of the plurality of geologic activity sensors 130-1 to 130-N, is transmitted to central monitoring system 120. In one embodiment, geologic activity data captured from each of the plurality of geologic activity sensors 130-1 to 130-N, is transmitted to central monitoring system 120 in real time, as it is captured. In one embodiment, a plurality of activity vectors, such as Activity_1, are received by central monitoring system 120 from each of the geologic activity sensors 130-1 to 130-N in real time. With the plurality of activity vectors, central monitoring system 120 is enabled to generate a three dimensional map of geologic activity data captured over geographical region 140. In one embodiment, central monitoring system 120 is adapted to generate a map comprising attitude, position, acceleration and velocity data based on a plurality of activity vectors from the plurality of geologic activity sensors 130-1 to 130-N at a particular instant of time. As one or more transient waves generated by a geological disturbance travels through geographical region 140, changes in the attitude, position, velocity and acceleration forces experienced by each of the plurality of geologic activity sensors 130-1 to 130-N are functions of factors including, but not limited to the magnitude, frequency, speed and direction of the one or more transient waves. In embodiments of the present invention, data from the plurality of geologic activity sensors 130-1 to 130-N, comprising sensor array 110, is continuously transmitted to central monitoring system 120. Central monitoring system 120 is adapted to correlate the activity data received from the plurality of activity sensors 130-1 to 130-N of sensor array 110 based on the precision time stamps, and to generate a moving map of geological disturbances in geographical region 140 in real time.

With the plurality of geologic activity sensors 130-1 to 130-N capturing activity from a plurality of locations, central monitoring system 120 is further enabled to calculate characteristics of transient waves, including, but not limited to magnitudes, frequencies, speed and direction of travel. In one embodiment, central monitoring system 120 is adapted to generate one or more three dimensional representations of wave characteristics based on the correlated data received from sensor array 110. Additionally, in one embodiment, the exact attitude, position, velocity and acceleration of one or more tectonic plates is also very accurately characterized by correlating the data from the plurality of geologic activity sensors 130-1 to 130-N in sensor array 110. With this data, the present invention can detect plate wave activity, such as plate motion and phase relationships of movements across the plate, and generate a single moving picture of the plate.

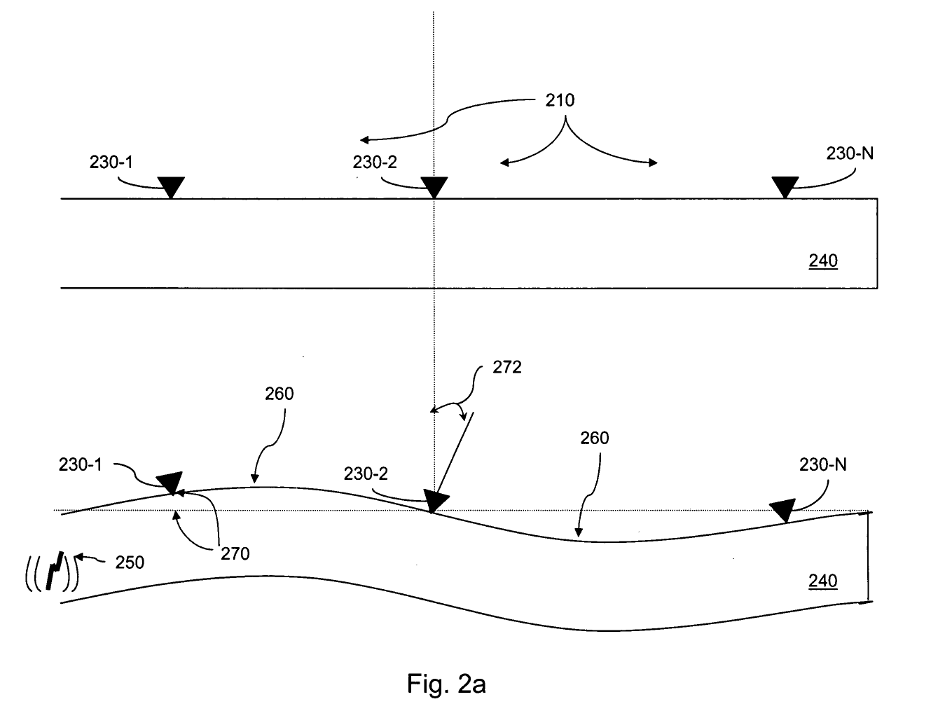

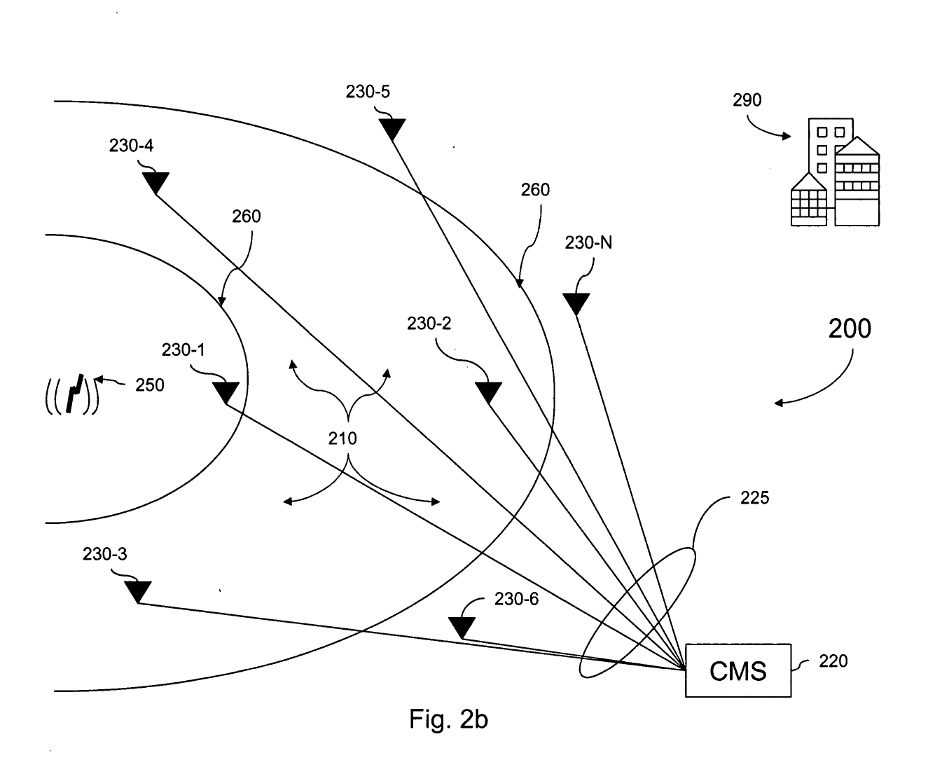

As illustrated in FIGS. 2a and 2b, one embodiment 200 of the present invention tracks the location and intensity of wave motion generated by geological disturbances. Geographical area 240 (FIG. 2a shown in cross section) is monitored by sensor array 210 having a plurality of geologic activity sensors 230-1 to 230-N of the type discussed in FIGS. 1a and 1b. When disturbance 250 initiates a traveling wave 260 within geographical area 240, each geologic activity sensor 230-1 to 230-N measures its own three dimensional position displacement 270, attitude change 272, velocity and the magnitude of acceleration forces acting upon it. In one embodiment, each geologic activity sensor 230-1 to 230-N transmits the data to central monitoring unit 220 via one or more communication links 225. By correlating the coherent data generated from sensor array 210, central monitoring system 220 can calculate frequency, amplitude, speed and direction of wave 260 as it propagates through geographical area 240. In one embodiment, based on data from sensor array 210, central monitoring system 220 is adapted to generate a three dimensional representation of the acceleration forces acting on geographical area 240. In one embodiment, based on data from sensor array 210, central monitoring system 220 is adapted to generate a three dimensional representation of the physical displacement of geological structures within geographic area 240.

Although the example provided in FIGS. 2a and 2b characterize geographic area 240 as a landmass, that need not be the case as part or all of geographic area 240 may include a body of water, such as an ocean. In one embodiment, one or more of sensors 230-1 to 230-N may be mounted on floating buoys or other floating structure. In such a configuration, embodiments of the present invention are well adept at tracking ocean waves, such as potentially destructive tsunamis, resulting from geological disturbances. In one embodiment, sensor array 210 is distributed over a large geographic area 240 that includes an open ocean. Central monitoring system 210 is adapted to track one or more waves propagating across an ocean in order to provide a tsunami early warning system to coastal cities 290 or other coastal areas. In one embodiment, central monitoring system 210 is adapted to predict when a traveling wave will hit one or more costal areas 290 based on the correlated data acquired from sensor array 210.

As would be readily recognized by one skilled in the art upon reading this specification and the illustration of FIGS. 2a and 2b, additional benefits of using coherent data from multiple geographical activity sensors include that central monitoring system 220 can be further adapted to identify local disturbances affecting only an isolated number of geologic activity sensors and differentiate them from waves propagating over larger areas. Similarly, central monitoring system 220 can be adapted to pulling out common factors uniformly affecting the entire sensor array 210 and identify anomalies.

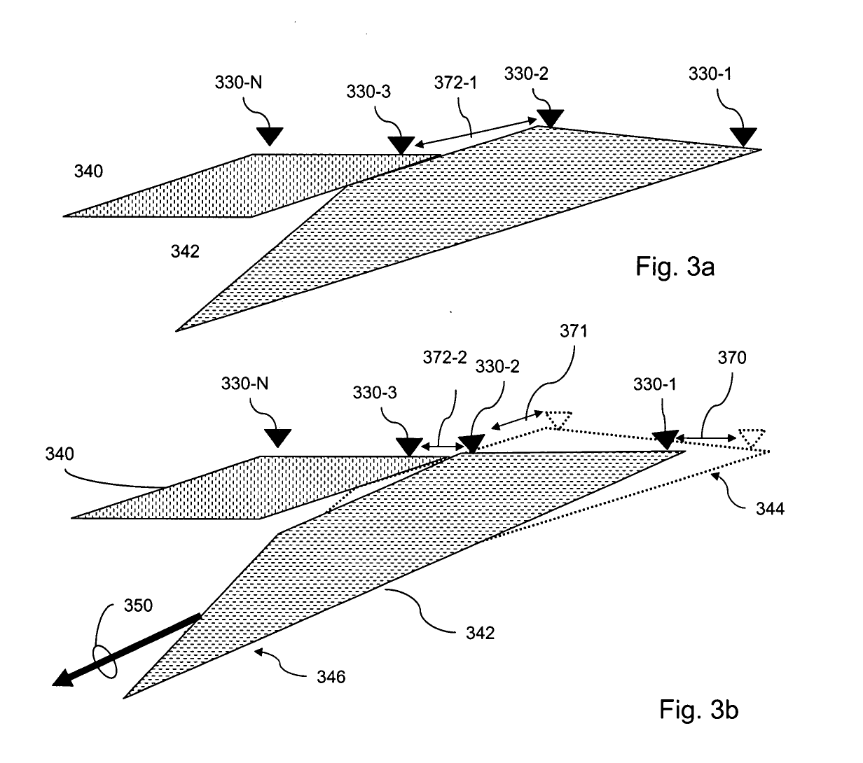

As illustrated in FIGS. 3a and 3b, in one embodiment 300 the present invention measures the relative motion of one or more tectonic plates in real time. In one embodiment, a plurality of geologic activity sensors, such as sensors 330-1 and 330-2 are dispersed over an area comprising a tectonic plate 342. As tectonic plate 342 moves (as shown by 350) and shifts in location from 344 to 346, sensors 330-1 and 330-2 sense their own respective displacements 370 and 371. A central monitoring system 320 receives the data from sensors 330-1 and 330-2 and translates the displacement of the individual sensors into a map illustrating the displacement of plate 342. In another embodiment, a plurality of geologic activity sensors, such as sensors 330-1 and 330-N are dispersed over an area comprising two or more tectonic plates 340 and 342. As two or more tectonic plates, such as tectonic plates 342 and 340, shift in position relative to each other, having sensors 330-1 to 330-N on both plates 342 and 340 further allows central monitoring system 320 to directly measure the change in distances between points, such as the change from distance 372-1 to distance 372-2 between sensors 330-2 and 330-3. This direct measurement further allows central monitoring system 320 to characterize the relative motion of one or more tectonic plates, and their effects on each other. In one embodiment, central monitoring system 320 is adapted as described in regards to FIGS. 2a and 2b, to generate a three dimensional representation of the physical displacement of geological structures within plates 342 and 340 and in one embodiment, further to calculate frequency, amplitude, speed and direction of wave motions propagating through plates 342 and 340 due to the relative motion of the plates.

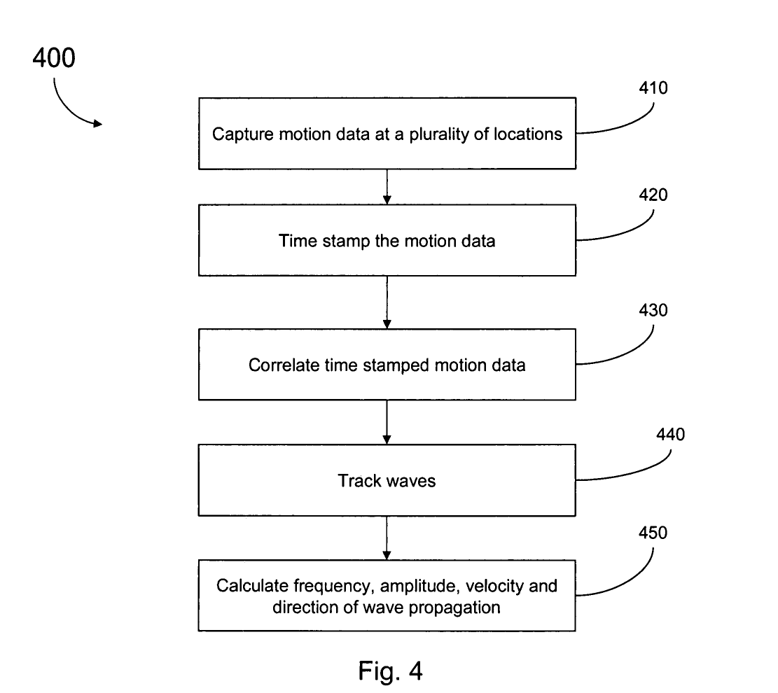

FIG. 4 provides a flow chart illustrating a method 400 for monitoring geological events of one embodiment of the present invention. The method comprises capturing motion data at a plurality of locations within a geographic area (410), time stamping the motion data (420), correlating the time stamped motion data (430), and tracking the location and intensity of one or more waves generated by one or more geological disturbances (440). In one embodiment the method further comprises calculating one or more of frequency, amplitude, speed and direction of the one or more waves generated by one or more geological disturbances (450) based on the time stamped motion data captured at a plurality of locations. In one embodiment, capturing motion data comprises capturing one or more of attitude, position, acceleration, and velocity at the plurality of locations.

Embodiments of the present invention are also well adept to the task of locating underground oil and mineral deposits. One traditional method for locating such deposits involves initiating a shock wave at a first location in a geologic structure (typically using a device known in the art as a thumper), and measuring the time it takes for the shock wave to reach a second location. Using this traditional method, the speed of the traveling shock wave provides an indication of the type of material the shock wave traveled through.

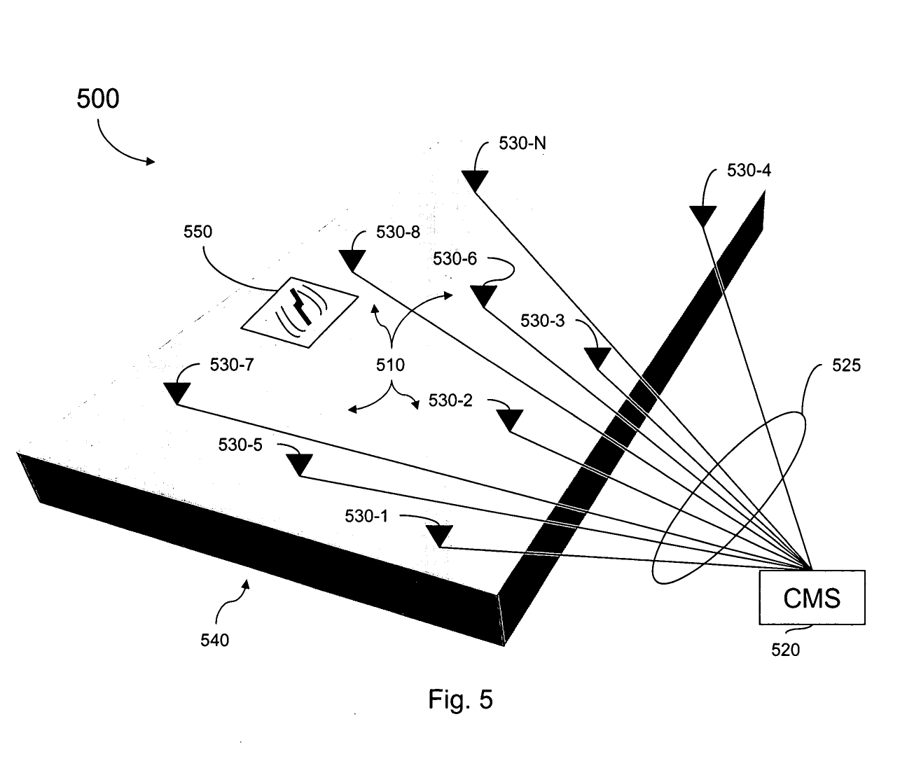

FIG. 5 illustrates an embodiment of the present invention for discovering and characterizing underground oil and mineral deposits. A sensor array 510 includes a plurality of geologic activity sensors 530-1 to 530-N distributed across a geographic area 540. Geologic activity sensors 530-1 to 530-N communicate with central monitoring system 520 using one of more communication links 525. In one embodiment, geographic area 540 is an area suspected to contain oil or mineral deposits. A machine 550 is adapted to produce elastic shock waves that propagate through geographic area 540. In one embodiment, machine 550 is a machine typically referred to in the oil and mineral exploration art as a thumper. Central monitoring system 520 is adapted to correlate data received from sensor array 510 based on precision time stamps, and map geological events in geographical region 540 in real time. In one embodiment, central monitoring system 520 is adapted to generate one or more three dimensional representations of propagating wave energy based on the time stamped correlated data received from sensor array 510.

In operation, in one embodiment, machine 550 injects an elastic shock wave within geographical area 540. Each sensor 530-1 to 530-N measures its own three dimensional displacement, attitude change, velocity and magnitude and direction of acceleration forces acting upon it. By correlating the coherent data from sensor array 510, central monitoring system 520 can calculate frequency, amplitude, speed and direction of traveling waves initiated by machine 550. It is known in the art that the speed of shock waves traveling through different geological structures is proportional to the density of the material the wave travels through. For example, sands and shales transmit waves with relatively low velocity. Weak sandstones and limestones transmit waves with relatively higher speed. Crystalline rocks such as limestones, rock salt, schists, and igneous rocks allow waves to propagate at still relatively higher speeds. With data from sensor array 510, central monitoring system 520 characterizes wave motions and phase relationships of movements across geographic area 540 of shock waves generated by machine 550. In one embodiment, central monitoring system 520 correlates the wave motions and phase relationship characteristics with what materials have been known to produce those characteristics in the past, in order to produce a map of the mineral or oil deposits located beneath geographic area 540.

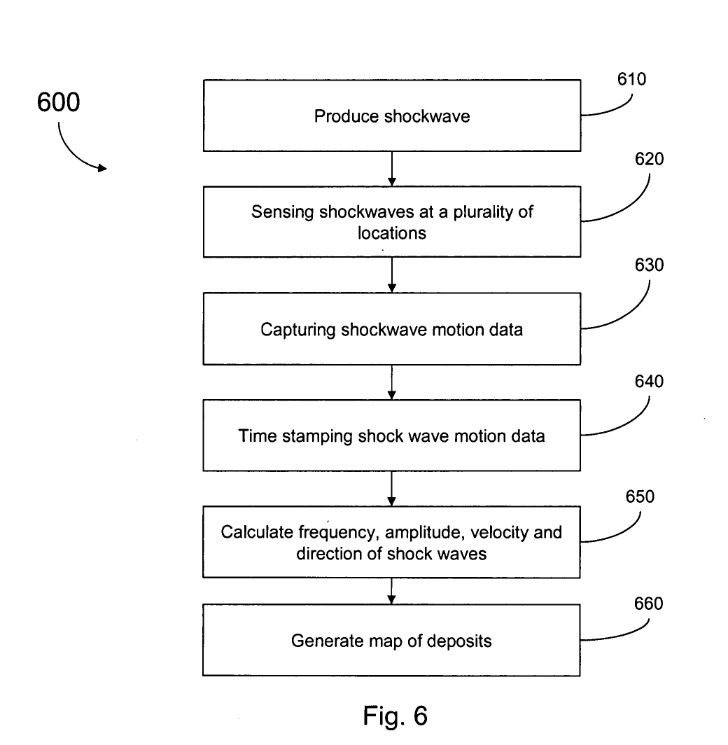

FIG. 6 is a flow diagram illustrating a method 600 for locating underground oil and mineral deposits of one embodiment of the present invention. The method comprises producing one or more traveling shock waves through a geographic area (610), sensing shock wave motions at a plurality of locations within the geographic area (620), capturing the shock wave motion data (630), and time stamping the shock wave motion data (640) with a time indicating when the shock wave motion data was captured. The method further comprises calculating one or more of frequency, amplitude, speed and direction of the one or more traveling shock waves (650) and generating a map of deposits located within the geographic area by evaluating the time stamped motion data (660).

Several means are available to implement the central monitoring system of the current invention. These means include, but are not limited to, digital computer systems, programmable controllers, or field programmable gate arrays. Therefore other embodiments of the present invention are program instructions resident on computer readable media which when implemented by such controllers, enable the controllers to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A geological event monitoring system, the system comprising:
a sensor array; and
a central monitoring system adapted to communicate with the sensor array, wherein the sensor array measures activity at a plurality of locations and transmits time stamped data characterizing the activity at the plurality of locations to the central monitoring system, the central monitoring system further adapted to correlate the time stamped data and map geological events in real time.

2. The system of claim 1, wherein the central monitoring system is further adapted to track one or more waves propagating across an ocean and further adapted to predict when the one or more waves will hit one or more coastal areas.

3. The system of claim 1, wherein the central monitoring system is further adapted to track the location and intensity of a wave propagating through a geographic area, generated by one or more geological disturbances.

4. The system of claim 3, wherein the central monitoring system is further adapted to calculate one or more of frequency, amplitude, speed and direction of a wave propagating through a geographic area.

5. The system of claim 3, wherein the central monitoring system is further adapted to detect tectonic plate wave motion and phase relationships of movements across one or more tectonic plates.

6. The system of claim 3, wherein the central monitoring system is further adapted to generate one or more three dimensional representations of wave characteristics based on correlated time stamped data.

7. The system of claim 1, wherein the central monitoring system is further adapted to characterize one or more of the attitude, position, velocity and acceleration of one or more tectonic plates in real time.

8. The system of claim 1, wherein the sensor array further comprises:
a plurality of geologic activity sensors distributed within a geographical area, wherein each geologic activity sensor is adapted to monitor and capture motion data including at least one of attitude, position, acceleration, and velocity of the geologic activity sensor; and
wherein each geologic activity sensor is further adapted to time stamp the motion data.

9. The system of claim 8, wherein each geologic activity sensor further comprises at least one of one or more gyroscopes, and one or more accelerometers.

10. The system of claim 8, further comprising:
a GPS receiver adapted to output the geologic activity sensor's position.

11. The system of claim 3, wherein one or more of the plurality of geologic activity sensors is an inertial navigation unit adapted with a GPS receiver.

12. The system of claim 1, further comprising:
a geologic thumper adapted to produce one or more traveling shock waves through a geographic area, wherein the central monitoring system is further adapted to calculate one or more of frequency, amplitude, speed and direction of the one or more traveling shock waves and correlate the wave motions and phase relationship characteristics to produce a map of one or more deposits located beneath the sensor array.

13. A geological disturbance monitoring system, the system comprising:
a plurality of means for geologic activity sensing, wherein each means for geologic activity sensing is adapted to monitor and capture motion data including at least one of the means for motion sensing's attitude, position, acceleration, and velocity;
means for capturing motion data sensed by the plurality of means for geologic activity sensing;
means for time stamping the motion data captured;
means for correlating the time stamped motion data; and
means for mapping one or more geological disturbances in real time, based on correlated time stamped motion data.

14. The system of claim 13, further comprising:
means for tracking one or more waves generated by the one or more geological disturbances across an ocean; and
means for predicting when the one or more waves will hit one or more coastal areas.

15. The system of claim 13, further comprising:
means for tracking tectonic plate wave motion and phase relationships of movements across one or more tectonic plates.

16. The system of claim 13, further comprising:
means for generating one or more three dimensional representations of wave characteristics based on correlated time stamped motion data.

17. The system of claim 13, further comprising:
means for characterizing one or more of the attitude, position, velocity and acceleration of one or more tectonic plates in real time.

18. The system of claim 13, further comprising:
means for producing one or more traveling shock waves through a geographic area; and
means for calculating one or more of frequency, amplitude, speed and direction of the one or more traveling shock waves.

19. The system of claim 18, further comprising:
means for generating a map of one or more deposits located within the geographic area by evaluating the correlated time stamped motion data.

20. A method for locating underground oil and mineral deposits, the method comprising:
producing one or more traveling shock waves through a geographic area;
sensing shock wave motions at a plurality of locations within the geographic area;
capturing shock wave motion data based on the sensed shock wave motion at the plurality of locations within the geographic area;
time stamping the shock wave motion data with a time indicating when the shock wave motion data was captured;
calculating one or more of frequency, amplitude, speed and direction of the one or more traveling shock waves; and
generating a map of deposits located within the geographic area by evaluating the time stamped motion data.

21. A method for monitoring geological events, the method comprising:
capturing motion data at a plurality of locations within a geographic area;
time stamping the motion data captured at a plurality of locations within a geographic area;
correlating the time stamped motion data; and
tracking the location and intensity of one or more waves generated by one or more geological events.

22. The method of claim 21, the method further comprising:
calculating one or more of frequency, amplitude, speed and direction of the one or more waves generated by one or more geological events.

23. The method of claim 21, wherein capturing motion data includes capturing at least one of attitude, position, acceleration, and velocity data.

24. The method of claim 21, further comprising:
tracking one or more waves propagating across an ocean; and
calculating when the one or more waves will hit one or more coastal areas.

25. A computer-readable medium having computer-executable program instructions for a method for monitoring geological events, the method comprising:
capturing motion data at a plurality of locations within a geographic area;
time stamping the motion data captured at a plurality of locations within a geographic area;
correlating the time stamped motion data; and
tracking the location and intensity of one or more waves generated by one or more geological events.

26. The method of claim 25, the method further comprising:
calculating one or more of frequency, amplitude, speed and direction of the one or more waves generated by one or more geological events.

27. The method of claim 25, wherein capturing motion data includes capturing at least one of attitude, position, acceleration, and velocity data.

28. The method of claim 25, further comprising:
tracking one or more waves propagating across an ocean; and
calculating when the one or more waves will hit one or more coastal areas.

29. A computer-readable medium having computer-executable program instructions for a method for locating underground oil and mineral deposits, the method comprising:
producing one or more traveling shock waves through a geographic area;
sensing shock wave motions at a plurality of locations within the geographic area;
capturing shock wave motion data based on the sensed shock wave motion at the plurality of locations within the geographic area;
time stamping the shock wave motion data with a time indicating when the shock wave motion data was captured;
calculating one or more of frequency, amplitude, speed and direction of the one or more traveling shock waves; and
generating a map of deposits located within the geographic area by evaluating the time stamped motion data.
